(19) United States
(12) Patent Application Publication
(10) Pub. No.: US 2025/0149822 A1
(43) Pub. Date: May 8, 2025

(54) CONNECTOR DEVICE

(71) Applicant: SUMITOMO WIRING SYSTEMS, LTD., Mie (JP)

(72) Inventor: Kazuo NAKAI, Mie (JP)

(21) Appl. No.: 18/730,794

(22) PCT Filed: Jan. 9, 2023
(86) PCT No.: PCT/JP2023/000241

§ 371 Date: Jul. 22, 2024

(30) Foreign Application Priority Data
Jan. 24, 2022 (JP) 2022-008652

(51) Int. Cl. H01R 13/52

(52) U.S. Cl. CPC H01R 13/5202

(57) ABSTRACT

A connector device (10) includes a connector (20) and a mating connector (30) connectable to the connector (20) from front. The mating connector (30) includes a tubular receptacle (33). The connector (20) includes a housing (40) having a housing body (41) to be fit into the receptacle (33), and a sealing member (60) to be held in close contact with the receptacle (33) by being mounted on an outer peripheral surface of the housing body (41). A protrusion (90) for filling a gap between the housing body (41) and the receptacle (33) is provided on the outer peripheral surface of the housing body (41). The protrusion (90) can face and contact the sealing member (60) from a front side.

### TECHNICAL FIELD

The present disclosure relates to a connector device.

### BACKGROUND

A connector disclosed in Patent Document 1 is provided with a male housing and a female housing connectable to each other. The male housing includes a receptacle. The female housing includes a tower portion configured to accommodate terminal fittings and to be externally fit to the receptacle. A front holder to be mounted on the tower portion is provided with an outer protrusion projecting toward the inner peripheral surface of the receptacle.

In a connector disclosed in Patent Document 2, a sealing member is mounted on the outer periphery of an inner housing of a female housing. A retainer for locking female terminal fittings is provided with a front stop portion for stopping the sealing member to prevent any further forward movement. In a connector disclosed in Patent Document 3, a front wall member separate from a housing body and configured to stop a sealing member to prevent any further forward movement is mounted on the housing body of a female housing.

### PRIOR ART DOCUMENT

### Patent Document

Patent Document 1: JP 2008-016262 A
Patent Document 2: JP 2009-093896 A
Patent Document 3: JP 2015-220169 A

### SUMMARY OF THE INVENTION

### Problems to be Solved

If an attempt is made to make a connector as shown in Patent Document 1 have a waterproof structure, a sealing member and a retaining member as shown in Patent Documents 2 and 3 need to be provided. By providing a component for suppressing rattling between housings after a retaining member is provided in this way, a configuration becomes complicated.

Accordingly, the present disclosure aims to provide a technique capable of suppressing rattling between a housing of a connector and a receptacle of a mating connector and suppressing the detachment of a sealing member by a simple configuration.

### Means to Solve the Problem

The present disclosure is directed to a connector with a connector and a mating connector connectable to the connector from front, the mating connector including a tubular receptacle, the connector including a housing having a housing body to be fit into the receptacle and a sealing member to be held in close contact with the receptacle by being mounted on an outer peripheral surface of the housing body, a protrusion for filling a gap between the housing body and the receptacle being provided on the outer peripheral surface of the housing body, and the protrusion being capable of facing and contacting the sealing member from a front side.

### Effect of the Invention

According to the present disclosure, it is possible to suppress rattling between a housing of a connector and a receptacle of a mating connector and suppress the detachment of a sealing member by a simple configuration.

### BRIEF DESCRIPTION OF THE DRAWINGS

FIG. 1 is a perspective view showing a connector device of a first embodiment.

FIG. 2 is an exploded perspective view of the connector device.

FIG. 3 is a perspective view showing a connector.

FIG. 4 is a front view showing the connector.

FIG. 5 is a section along A-A of FIG. 4.

FIG. 6 is a right side view of an upper protrusion.

FIG. 7 is a plan view of the upper protrusion.

FIG. 8 is a section along B-B of FIG. 4.

FIG. 9 is a section along C-C of FIG. 1.

FIG. 10 is a section along D-D of FIG. 1.

FIG. 11 is a section along E-E of FIG. 1.

FIG. 12 is a perspective view showing a connector device of a second embodiment.

FIG. 13 is a perspective view showing a connector.

FIG. 14 is a plan view of an upper protrusion.

FIG. 15 is a section along F-F of FIG. 12.

### DETAILED DESCRIPTION TO EXECUTE THE INVENTION

### Description of Embodiments of Present Disclosure

First, embodiments of the present disclosure are listed and described.
(1) The connector device of the present disclosure is provided with a connector and a mating connector connectable to the connector from front, the mating connector including a tubular receptacle, the connector including a housing having a housing body to be fit into the receptacle and a sealing member to be held in close contact with the receptacle by being mounted on an outer peripheral surface of the housing body, a protrusion for filling a gap between the housing body and the receptacle being provided on the outer peripheral surface of the housing body, and the protrusion being capable of facing and contacting the sealing member from a front side.

According to the configuration of the present disclosure, since the gap between the housing body and the receptacle of the mating connector is filled by the protrusion, rattling between the housing body and the receptacle of the mating connector is suppressed. Further, forward detachment of the sealing member from the housing body is suppressed by the protrusion contacting the sealing member from behind in a connection direction of the mating connector. Therefore, the connector device can have both a function of suppressing rattling between the housing of the connector and the receptacle of the mating connector and a function of suppressing the detachment of the sealing member by a simple configuration of providing the protrusion.
(2) Preferably, the protrusion has a top part provided on a tip side in a projecting direction, and a curved surface continuous from a front end of the protrusions to the top part.

According to this configuration, the sealing member is less likely to be damaged when riding over the curved surface as compared to a case where a front end side of the protrusion is angular.
(3) Preferably, the protrusion has a curved surface convex forward from the front end of the protrusion to the top part when viewed from the projecting direction.

According to this configuration, the sealing member is less likely to be damaged when contacting the front end side of the protrusion as compared to a case where the front end side of the protrusion is angular when viewed from the projecting direction.
(4) Preferably, the protrusion has an inclined surface approaching the housing body from the top part toward a rear side.

According to this configuration, the deformation of the sealing member riding over the inclined surface can be gently restored.
(5) Preferably, a rear end surface of the protrusion is disposed along the projecting direction of the protrusion from the housing body.

According to this configuration, the rear end surface of the protrusion more easily interferes with the sealing member in a front-rear direction and the sealing member is more easily stopped to prevent any further forward movement by the rear end surface of the protrusion as compared to a configuration in which the rear end surface of the protrusion is inclined to the projecting direction of the protrusion.
(6) Preferably, the rear end surface of the protrusion is a curved surface convex rearward when viewed from the projecting direction of the protrusion.

According to this configuration, the sealing member is less likely to be damaged when contacting the rear end surface of the protrusion from the rear side as compared to a configuration in which the rear end of the protrusion is angular when viewed form the projecting direction.

### DETAILS OF EMBODIMENTS OF PRESENT DISCLOSURE

### First Embodiment

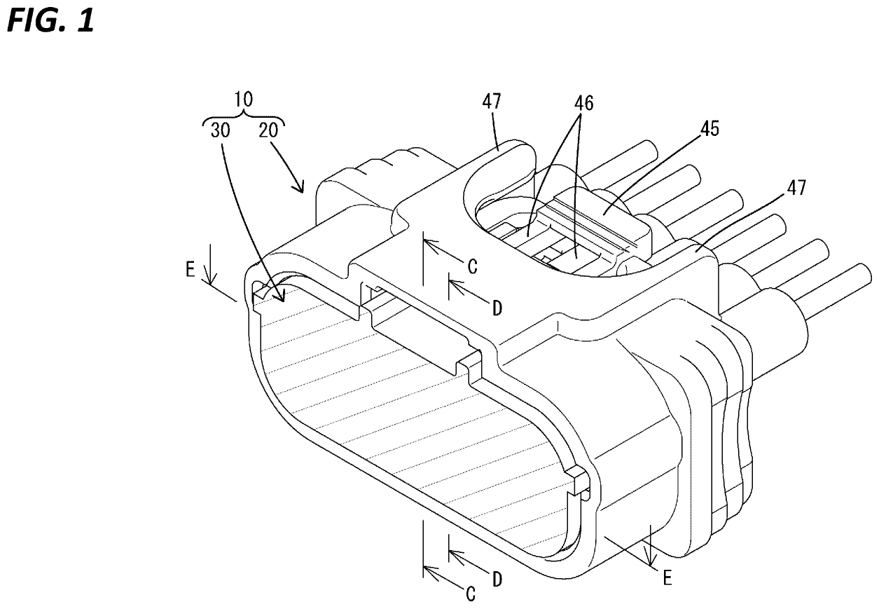

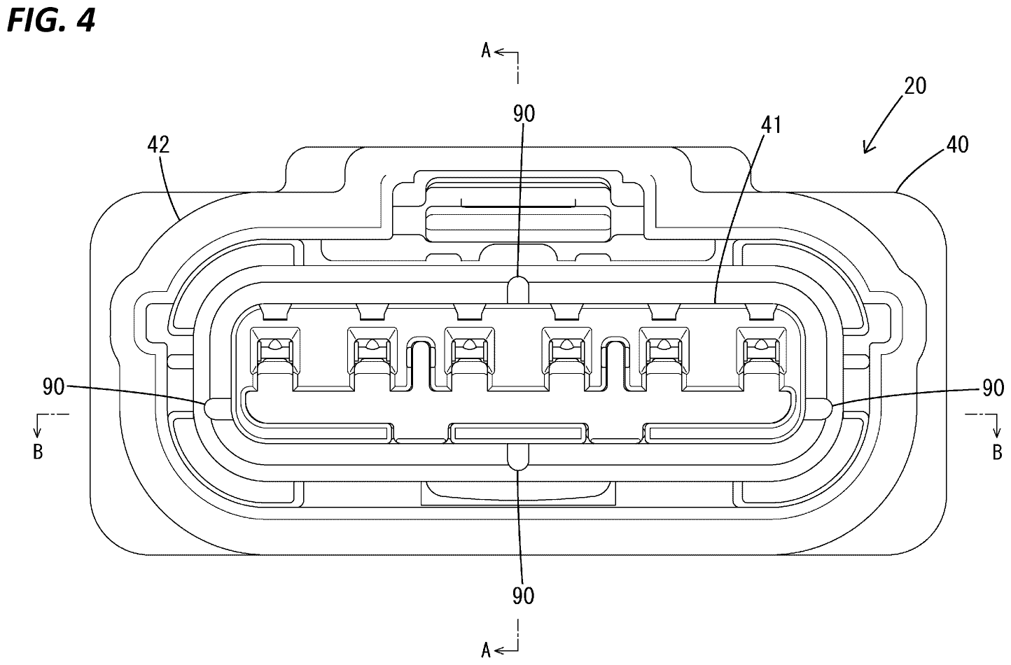

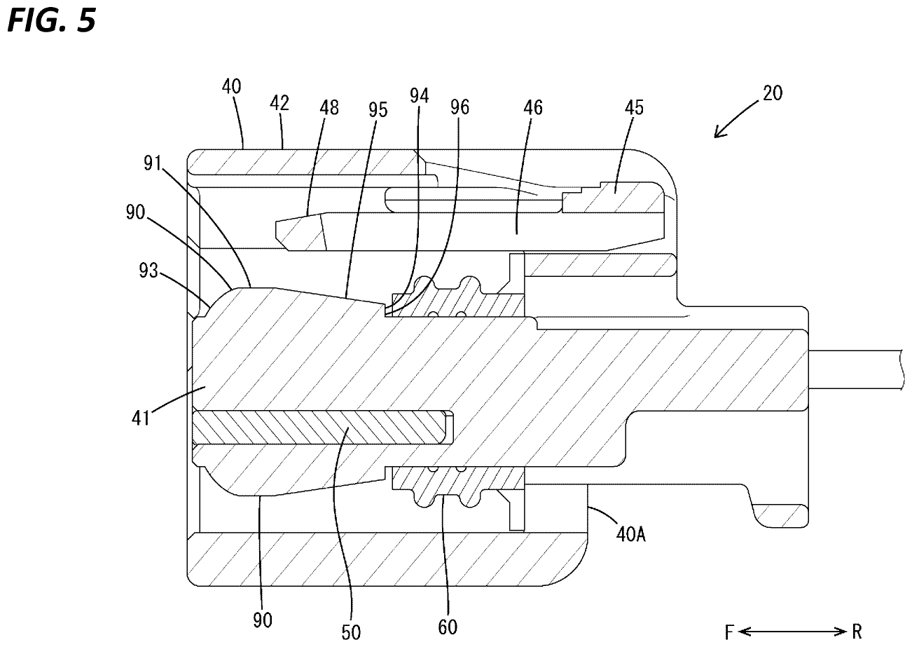

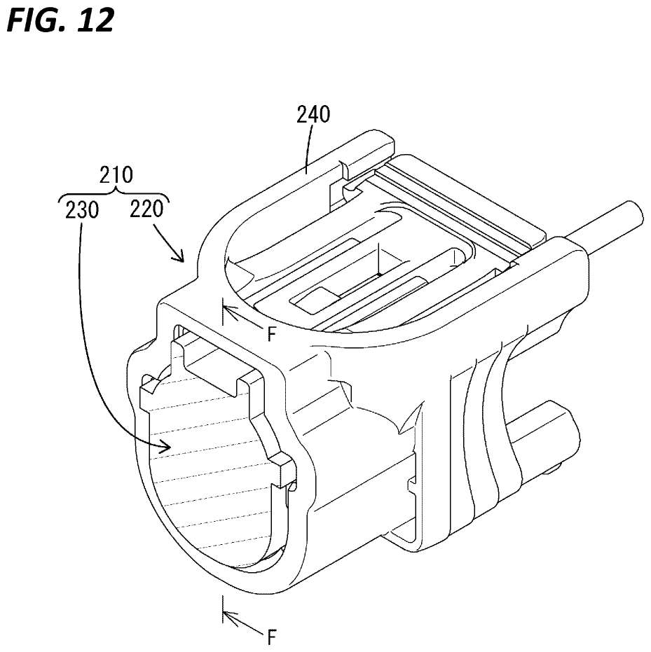

A specific first embodiment of a connector device of the present disclosure is described with reference to FIGS. 1 to 11. In the first embodiment, a side facing a mating connector to be connected is referred to as a front side concerning a front-rear direction in the description of each connector. For example, a left side (facing side of an arrow F) of FIG. 5 is referred to as the front side and a right side (facing side of an arrow R) is referred to as a rear side. Further, upper and lower sides are based on a vertical direction of FIGS. 4, 5, 9 and 10. Further, left and right sides are based on a lateral direction of FIG. 4.

### (Configuration of Connector Device)

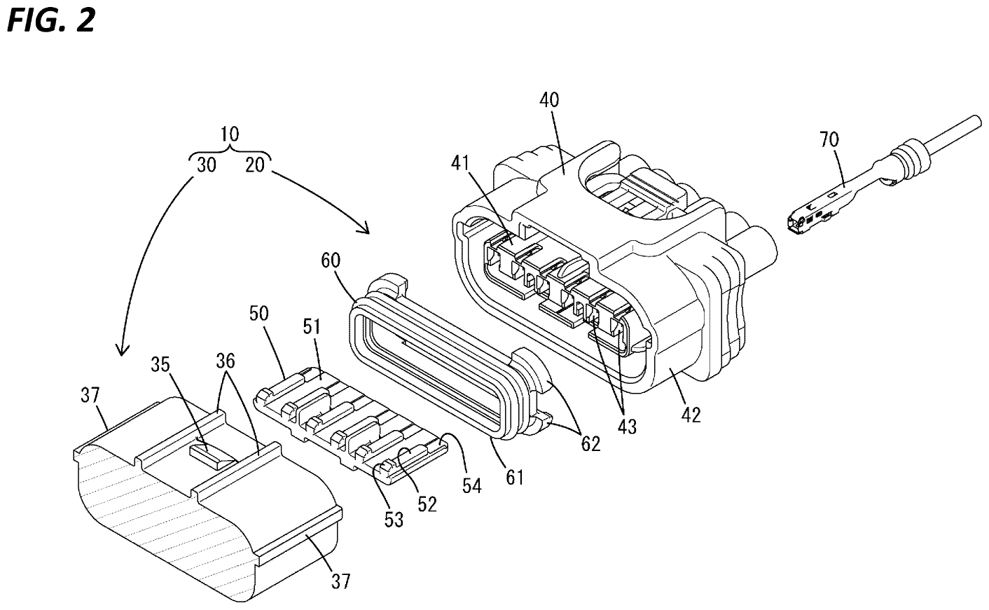

A connector 10 of the first embodiment is provided with a connector 20 and a mating connector 30 as shown in FIGS. 1 and 2. The mating connector 30 is connectable to the connector 20 from front. The connector 20 is a female connector. The mating connector 30 is a male connector. By connecting the respective connectors 20, 30, terminal fittings 70 of the connector 20 and mating terminal fittings 32 of the mating connector 30 are connected.

### (Configuration of Mating Connector)

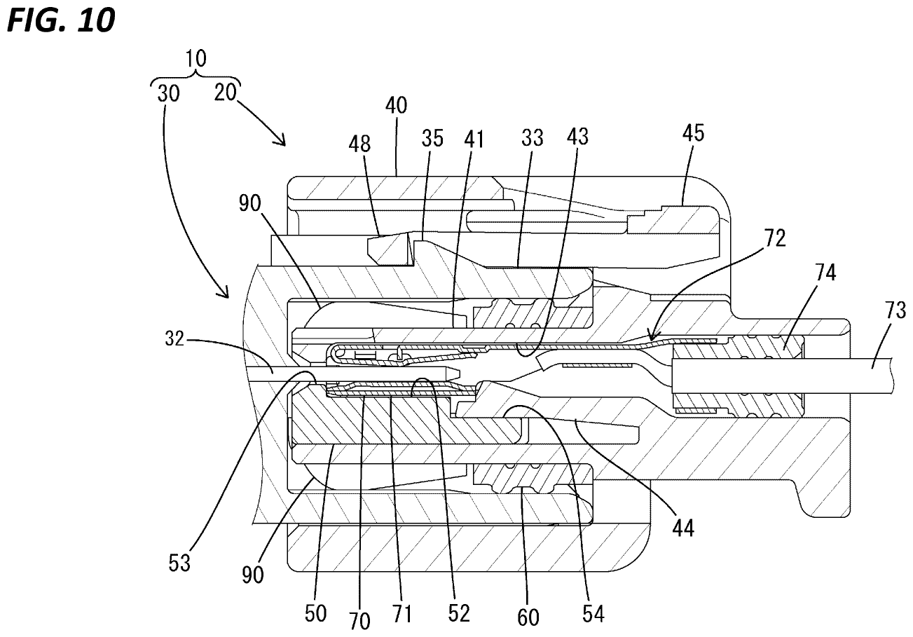

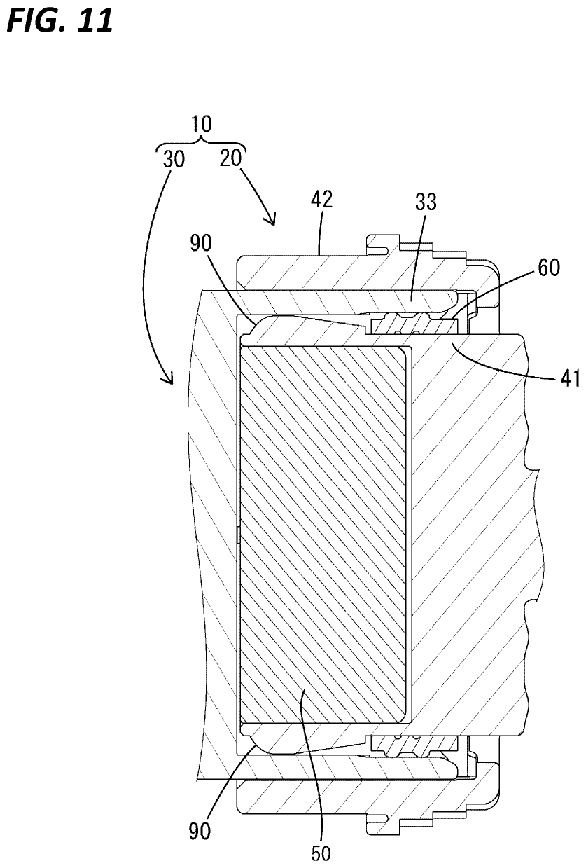

As shown in FIG. 2, the mating connector 30 includes a mating housing 31 and the mating terminal fittings 32. The mating housing 31 is made of synthetic resin. The mating housing 31 is in the form of a tube elliptical when viewed from the front-rear direction. A front part of the mating housing 31 constitutes a tubular receptacle 33. A plurality of the mating terminal fittings 32 are accommodated inside the receptacle 33 while horizontally projecting from a back wall 34 (see FIG. 10). In the first embodiment, six mating terminal fittings 32 are disposed in parallel at equal intervals in a width direction (lateral direction).

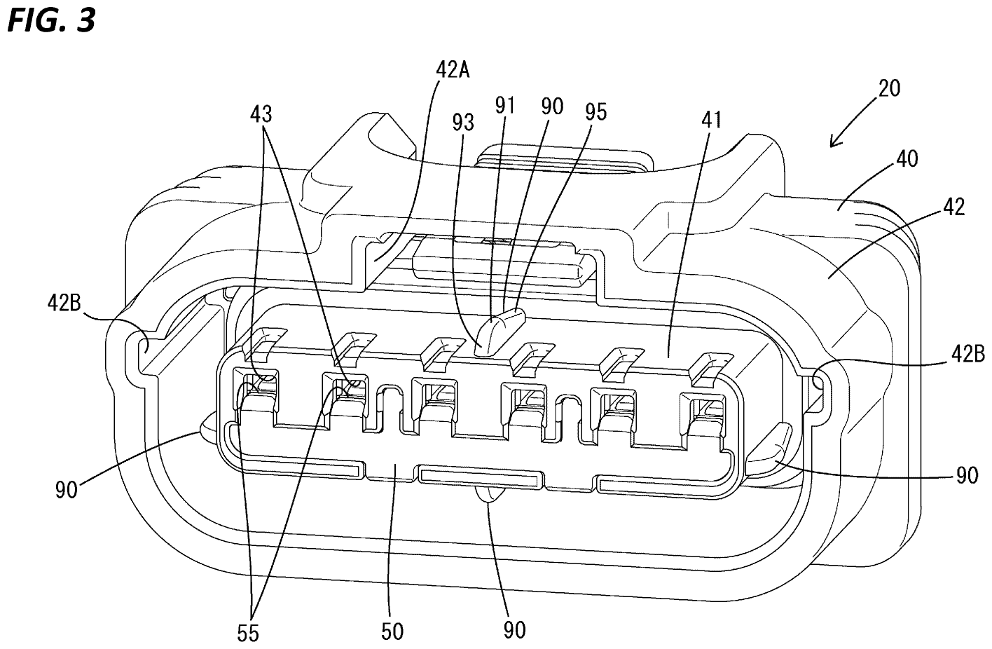

As shown in FIG. 2, a receiving portion 35 is formed to project in a center in the width direction (lateral direction) on the upper surface of the receptacle 33. The receiving portion 35 is locked to a lock arm 45 of the connector 20 to be described later. On the upper surface of the receptacle 33, a pair of first projections 36 long in the front-rear direction are provided on both widthwise sides of the receiving portion 35. The first projections 36 enter a first groove 42A (see FIG. 3) of the connector 20 to be described later. A pair of second projections 37 long in the front-rear direction are provided on side surfaces on both widthwise sides of the receptacle 33. The second projections 37 enter second grooves 42B (see FIG. 3) of the connector 20 to be described later.

### (Configuration of Connector)

As shown in FIG. 2, the connector 20 is provided with a housing 40, a retainer 50, a sealing member 60 and the terminal fittings 70.

The housing 40 is made of synthetic resin. The housing 40 is connectable to the mating housing 31 of the mating connector 30. As shown in FIG. 2, the housing 40 includes a housing body 41 and an outer tube portion 42. The housing body 41 is fit into the receptacle 33 of the mating housing 31 according to the connection of the respective connectors 20, 30.

As shown in FIGS. 2 and 10, the housing body 41 is provided with a plurality of (six in the first embodiment) cavities 43 for accommodating the terminal fittings 70. The plurality of cavities 43 are disposed in parallel in the width direction (lateral direction). As shown in FIG. 10, the cavity 43 is formed to penetrate through the housing body 41 in the front-rear direction. A cantilevered locking lance 44 is provided inside the cavity 43. The locking lance 44 is deflectable and deformable and can retain the terminal fitting 70 by resiliently locking the terminal fitting 70.

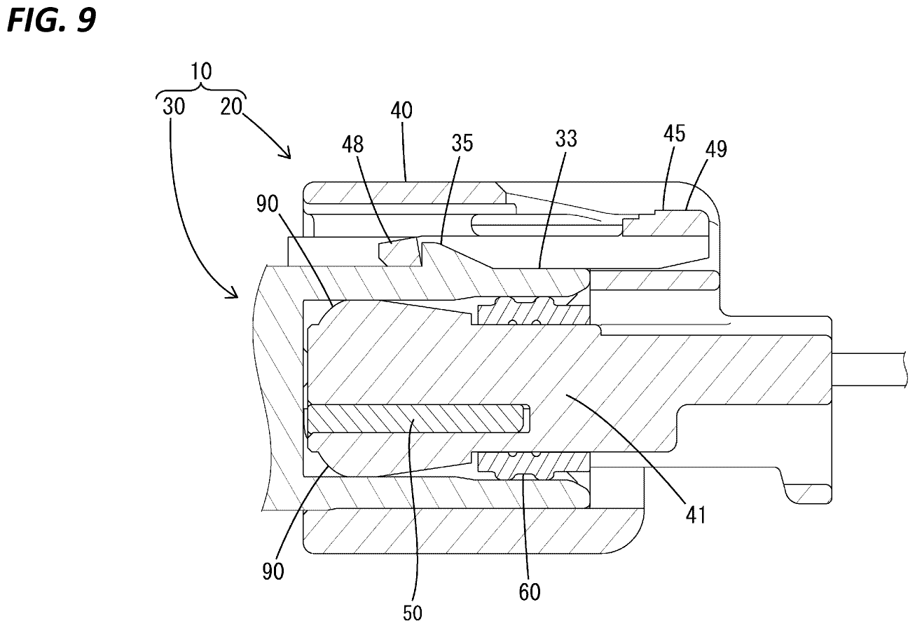

As shown in FIGS. 1 and 5, the lock arm 45 is provided on the upper surface of the housing body 41. As shown in FIG. 9, the lock arm 45 locks a connected state when the both connectors 20, 30 are connected. As shown in FIG. 1, the lock arm 45 includes a pair of arms 46 extending along the front-rear direction. The pair of arms 46 are respectively coupled to side walls 47 on both left and right sides provided on the upper surface of the housing body 41. Although not shown, the arm 46 is coupled to the side wall 47 at a position near a rear part in the front-rear direction. In this way, the lock arm 45 can be swingably displaced in the vertical direction with a part coupled to the side wall 47 as a center. The front ends of the both arms 46 are coupled by a lock portion 48 (see FIG. 4). As shown in FIG. 9, the lock portion 48 is locked to the receiving portion 35. The rear ends of the both arms 46 are coupled by an operating portion 49. By pressing the operating portion 49, a locked state of the respective connectors 20, 30 can be released.

As shown in FIG. 3, the outer tube portion 42 is provided with the first groove 42A and a pair of the second grooves 42B. The first groove 42A is recessed upward from an upper part of the inner surface of the outer tube portion 42. The pair of second grooves 42B are respectively recessed laterally outward from both left and right parts of the inner surface of the outer tube portion 42. The first and second grooves 42A, 42B are disposed along the front-rear direction. The first and second grooves 42A, 42B respectively guide the first projections 36 and the second projections 37 of the mating connector 30 at the time of connecting the respective connectors 20, 30.

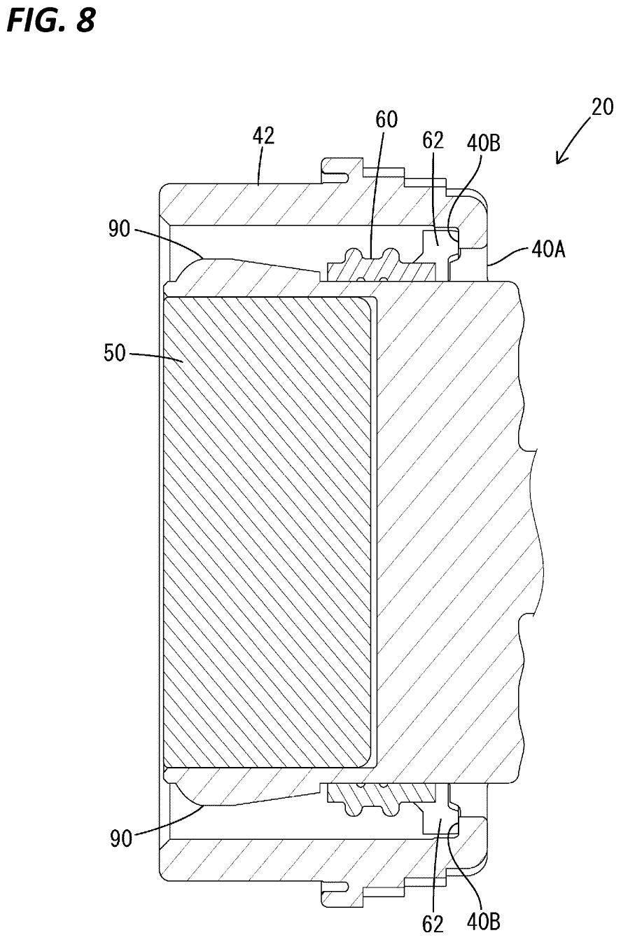

As shown in FIG. 5, the housing body 41 and the outer tube portion 42 are connected via a rear wall 40A. The rear wall 40A is disposed along the vertical direction from the rear end of the housing body 41 to the rear end of the outer tube portion 42. As shown in FIG. 8, recesses 40B recessed rearward are provided at four positions corresponding to protruding portions 62 of the sealing member 60 to be described later on the front surface of the rear wall 40A.

The retainer 50 is assembled with the housing body 41 from front. As shown in FIG. 2, the retainer 50 includes a body portion 51, first supporting portions 52, front stop portions 53 and second supporting portions 54. The first supporting portions 52, the front stop portions 53 and the second supporting portions 54 are provided to correspond to the respective cavities 43. The body portion 51 is in the form of a plate long in the width direction (lateral direction). The first supporting portion 52 projects upward from the body portion 51. The front stop portion 53 projects upward from the front end of the first supporting portion 52. The second supporting portion 54 is provided behind the first supporting portion 52 in the body portion 51. The second supporting portion 54 is recessed downward from the upper surface of the body portion 51. As shown in FIG. 10, the first supporting portion 52 supports a box portion 71 of the terminal fitting 70 from below. The second supporting portion 54 restricts the deflection and deformation of the locking lance 44 by contacting the locking lance 44 from below. The front stop portion 53 stops the terminal fitting 70 to prevent any further forward movement by contacting the box portion 71 from front.

By assembling the retainer 50 with the housing 40, six tab insertion holes 55 for stopping the terminal fittings 70 to prevent any further forward movements and allowing the entrance of the respective mating terminal fittings 32 are open in parallel in the width direction (lateral direction) as shown in FIG. 3.

As shown in FIG. 2, the sealing member 60 is in the form of a ring long in the width direction (lateral direction). The sealing member 60 is mounted on the outer peripheral surface of the housing body 41. The sealing member 60 includes a sealing body 61 and four protruding portions 62. The sealing body 61 is in the form of a ring long in the width direction (lateral direction). The four protruding portions 62 respectively protrude from four corner parts of the sealing body 61. As shown in FIG. 9, with the connection of the respective connectors 20, 30 completed, the sealing member 60 is disposed between the outer peripheral surface of the housing body 41 and the inner peripheral surface of the receptacle 33. The sealing member 60 is held in close contact with the housing body 41 and the receptacle 33 to seal between the respective connectors 20 and 30.

The sealing member 60 is fit to the housing body 41 from front, rides over protrusions 90 to be described later and is disposed on a rear end side of the outer peripheral surface of the housing body 41. As shown in FIG. 8, the sealing member 60 is stopped to prevent any further rearward movement by the front surface of the rear wall 40A of the housing 40. The protruding portions 62 of the sealing member 60 enter the recesses 40B of the rear wall 40A.

As shown in FIGS. 2 and 10, the terminal fitting 70 has a shape elongated in the front-rear direction as a whole. As shown in FIG. 10, the terminal fitting 70 includes the box portion 71 and a crimping portion 72. The box portion 71 constitutes a front part of the terminal fitting 70. The box portion 71 is in the form of a rectangular tube. The crimping portion 72 is in the form of an open barrel. The crimping portion 72 is crimped and connected to a sealing rubber plug 74 fit on an end of a wire 73. The wire 73 is pulled out rearward of the housing body 41 from the cavity 43.

### (Configuration of Protrusion)

As shown in FIGS. 3 and 4, four protrusions 90 are provided on the outer peripheral surface (upper, lower and both left and right surfaces) of the housing body 41. The upper and lower protrusions 90 are provided in a center in the width direction (lateral direction) of the housing body 41 and slightly behind the front end of the housing body 41 in the front-rear direction. The left and right protrusions 90 are provided at positions below a center in the vertical direction. The protrusion 90 has a shape elongated in the front-rear direction. As shown in FIGS. 9 to 11, the protrusions 90 fill a gap between the housing body 41 and the receptacle 33. Thus, rattling between the housing 40 and the mating housing 31 is suppressed. In this way, rattling between the terminal fittings 70 and the mating terminal fittings 32 is suppressed.

The protrusions 90 can face and contact the sealing member 60 from the front side. Thus, forward detachment of the sealing member 60 from the housing body 41 is suppressed. Therefore, the connector 20 can have both a function of suppressing rattling between the housing 40 and the mating housing 31 and a function of suppressing the detachment of the sealing member 60 by a simple configuration of providing the protrusions 90.

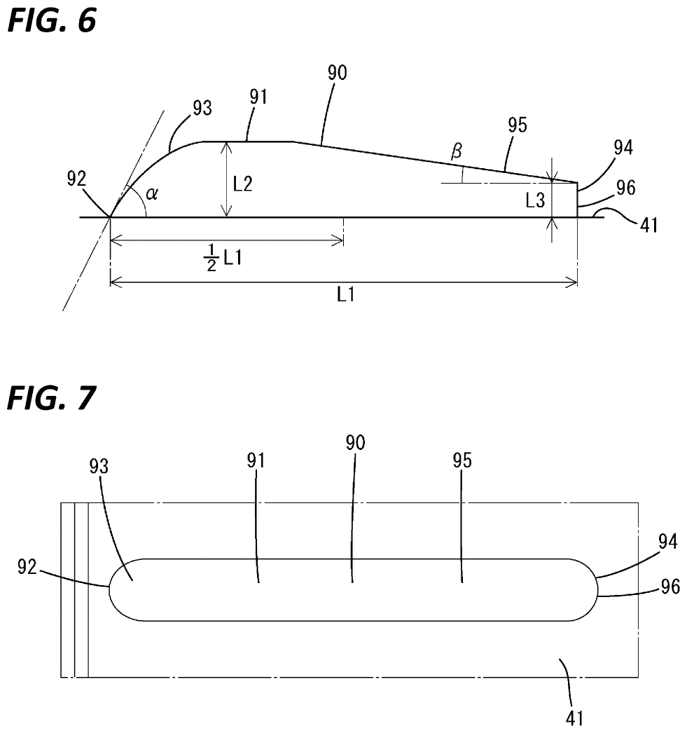

Although the upper protrusion 90 of the housing body 41 shown in FIG. 6 is described below, the other three protrusions 90 are also similarly configured.

As shown in FIGS. 3 and 4, the upper surface of the protrusion 90 is a curved surface convex upward when viewed from the front-rear direction. That is, an upper end appearing in a cross-section when the protrusion 90 is cut by an arbitrary plane orthogonal to the front-rear direction has an arc shape convex upward.

As shown in FIG. 6, a top part 91 is provided on a tip side of the protrusion 90 in a projecting direction (vertical direction). The top part 91 is provided at a position near a front side in the front-rear direction in the protrusion 90. The upper surface (top surface) of the top part 91 is disposed along the front-rear direction. The upper surface of the top part 91 is a curved surface convex upward when viewed from the front-rear direction.

As shown in FIG. 6, the protrusion 90 has a curved surface 93 continuous from a front end 92 to the top part 91. The curved surface 93 is the front surface (surface facing forward) of the protrusion 90. The curved surface 93 is arc-shaped when viewed from the width direction (lateral direction). By such a configuration, the sealing member 60 is less likely to be damaged when riding over the curved surface 93 as compared to a configuration in which the side of the front end 92 of the protrusion 90 is angular.

A rising angle α of the curved surface 93 shown in FIG. 6 is an angle between the upper edge of the housing body 41 and the upper edge of the base end of the curved surface 93 appearing when viewed from the width direction (lateral direction). That is, the angle α is an acute angle formed by a direction parallel to the upper edge of the housing body 41 and a tangential direction to the upper edge of the base end of the curved surface 93 when viewed from the width direction (lateral direction). The angle α is preferably 30° or more and 60° or less, more preferably 40° or more and 50° or less, and even more preferably 45°.

As shown in FIG. 7, the curved surface 93 is also a curved surface convex forward from the front end 92 to the top part 91 when viewed from the projecting direction (vertical direction). That is, a front edge appearing in a cross-section when the curved surface 93 is cut by an arbitrary plane orthogonal to the vertical direction has an arc shape convex forward. In this way, the sealing member 60 is less likely to be damaged when contacting the side of the front end 92 of the protrusion 90 as compared to a configuration in which the side of the front end 92 of the protrusion 90 is angular when viewed from the projecting direction (vertical direction).

As shown in FIG. 6, the protrusion 90 has an inclined surface 95 on the side of a rear end 94. The inclined surface 95 is continuous rearward from the top part 91 and inclined to approach the housing body 41 toward a rear side. The inclined surface 95 is continuous from the top part 91 to the rear end 94. The inclined surface 95 is also a surface convex upward when viewed from the front-rear direction. Thus, the deformation of the sealing member 60 riding over the inclined surface 95 can be gently restored.

An angle of inclination β of the inclined surface 95 shown in FIG. 6 is an angle formed between the upper edge of the housing body 41 and the upper edge of the inclined surface 95 appearing when viewed from the width direction (lateral direction). The angle β is smaller than the angle α. The angle β is preferably 5° or more and 45° or less, more preferably 8° or more and 30° or less, and even more preferably 10° or more and 20° or less.

As shown in FIG. 6, a rear end surface 96 of the protrusion 90 is disposed along the projecting direction (vertical direction) of the protrusion 90 from the housing body 41. Thus, the rear end surface 96 of the protrusion 90 more easily interferes with the sealing member 60 in the front-rear direction and the sealing member 60 is more easily stopped to prevent any further forward movement by the rear end surface 96 as compared to a configuration in which the rear end surface 96 of the protrusion 90 is inclined to the projecting direction (vertical direction).

As shown in FIG. 7, the rear end surface 96 of the protrusion 90 is a curved surface convex rearward when viewed from the projecting direction (vertical direction) of the protrusion 90. Thus, the sealing member 60 is less likely to be damaged when contacting the rear end surface 96 of the protrusion 90 from behind as compared to a configuration in which the rear end 94 of the protrusion 90 is angular when viewed from the projecting direction (vertical direction).

As shown in FIG. 6, if L1 denotes a length in the front-rear direction of the protrusion 90, the top part 91 is located within a half distance range of L1 behind the front end 92. Further, if L2 denotes a projecting length of the protrusion 90 from the outer peripheral surface of the housing body 41 (distance between the outer peripheral surface of the housing body 41 and the top surface of the top part 91) and L3 denotes a length in the projecting direction (vertical direction) of the rear end 94, L2 is about twice as large as L3.

### Effects of First Embodiment

In the connector device 10 of the first embodiment, the protrusions 90 for filling the gap between the housing body 41 and the receptacle 33 are provided on the outer peripheral surface of the housing body 41. The protrusions 90 can face and contact the sealing member 60. According to this configuration, since the gap between the housing body 41 and the receptacle 33 is filled by the protrusions 90, rattling between the housing 40 and the receptacle 33 is suppressed. Further, the protrusions 90 contact the sealing member 60 from behind in the connection direction of the mating connector 30, whereby forward detachment of the sealing member 60 from the housing body 41 is suppressed. Therefore, the connector device 10 can have both the function of suppressing rattling between the housing 40 and the mating housing 31 and the function of suppressing the detachment of the sealing member 60 by the simple configuration of providing the protrusions 90.

Further, the protrusion 90 includes the top part 91 provided on the tip side in the projecting direction and the curved surface 93 continuous from the front end 92 to the top part 91. In this way, the sealing member 60 is less likely to be damaged when riding over the curved surface 93 as compared to the configuration in which the side of the front end 92 of the protrusion 90 is angular.

Further, the protrusion 90 has the curved surface 93 convex forward from the front end 92 to the top part 91 when viewed from the projecting direction. In this way, the sealing member 60 is less likely to be damaged when contacting the side of the front end 92 of the protrusion 90 as compared to the configuration in which the side of the front end 92 of the protrusion 90 is angular when viewed from the projecting direction.

Further, the protrusion 90 has the inclined surface 95 approaching the housing body 41 from the top part 91 toward the rear side. In this way, the deformation of the sealing member 60 riding over the inclined surface 95 can be gently restored.

Further, the rear end surface 96 of the protrusion 90 is disposed along the projecting direction of the protrusion 90 from the housing body 41. In this way, the rear end surface 96 of the protrusion 90 more easily interferes with the sealing member 60 in the front-rear direction and the sealing member 60 is more easily stopped to prevent any further forward movement by the rear end surface 96 as compared to the configuration in which the rear end surface 96 of the protrusion 90 is inclined to the projecting direction of the protrusion 90.

Further, the rear end surface 96 of the protrusion 90 is a curved surface convex rearward when viewed from the projecting direction of the protrusion 90. In this way, the sealing member 60 is less likely to be damaged when contacting the rear end surface 96 of the protrusion 90 from behind as compared to the configuration in which the rear end of the protrusion 90 is angular when viewed from the projecting direction.

### Second Embodiment

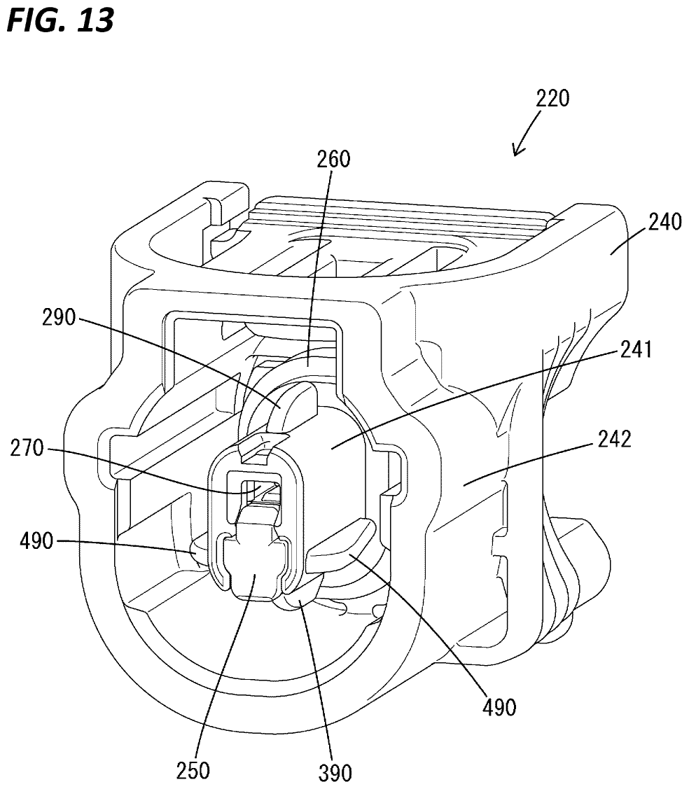

FIGS. 12 to 15 are drawings showing a connector device 210 of a second embodiment. The second embodiment differs from the first embodiment mainly in that a pair of a terminal fitting and a mating terminal fitting are provided.

As shown in FIG. 12, the connector device 210 of the second embodiment is provided with a connector 220 and a mating connector 230. The mating connector 230 includes one mating connector. As shown in FIG. 13, the connector 220 includes a housing 240, a retainer 250, a sealing member 260 and a terminal fitting 270 having functions similar to those of the housing 40, the retainer 50 and the sealing member 60 and the terminal fitting 70 of the connector 20 of the first embodiment. The connector 220 includes one terminal fitting 270.

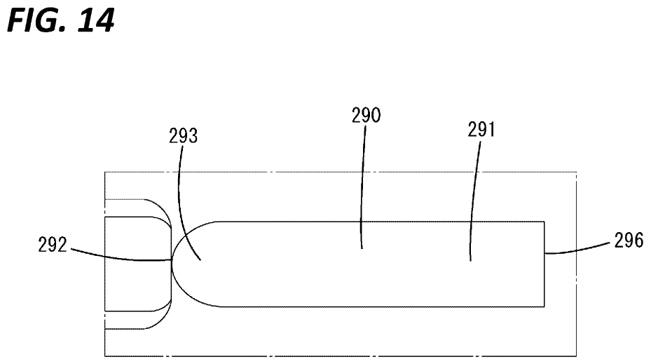

As shown in FIG. 13, a protrusion 290, a protrusion 390, a protrusion 490 and a protrusion 490 are respectively provided on the upper, lower, left and right surfaces of a housing body 241. The protrusions 290, 390 and 490 fill a gap between the housing body 241 and a receptacle 233. The protrusions 290, 390 and 490 can face and contact the sealing member 260 from front. The upper surface of the protrusion 290 is a curved surface convex upward when viewed from the front-rear direction. As shown in FIG. 14, a rear part of the protrusion 290 serves as a top part 291. The upper surface (top surface) of the top part 291 is disposed along the front-rear direction. The upper surface of the top part 291 is a curved surface convex upward when viewed from the front-rear direction.

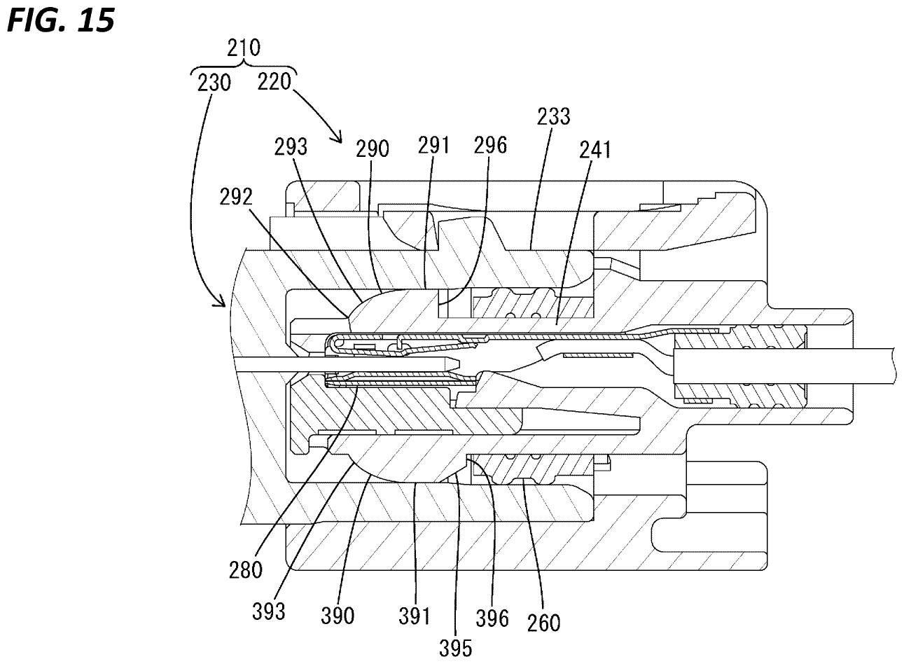

As shown in FIG. 15, the protrusion 290 has a curved surface 293 continuous from a front end 292 to the top part 291. The curved surface 293 is arc-shaped when viewed from the width direction (lateral direction). As shown in FIG. 14, the curved surface 293 is also a surface convex forward from the front end 292 to the top part 291 when viewed from the projecting direction (vertical direction). As shown in FIGS. 14 and 15, a rear end surface 296 of the protrusion 290 is disposed along the projecting direction (vertical direction) of the protrusion 290 from the housing body 241.

As shown in FIG. 15, the lower protrusion 390 has a top part 391, a curved surface 393, an inclined surface 395 and a rear end surface 396 configured similarly to the top part 91, the curved surface 93, the inclined surface 95 and the rear end surface 96 of the protrusion 90 of the first embodiment. The left and right protrusions 490 are configured similarly to the protrusions 90 of the first embodiment.

### Other Embodiments

The present invention is not limited to the above described and illustrated first and second embodiments, but is represented by claims. The present invention is intended to include all changes in the scope of claims and in the meaning and scope of equivalents and also include the following embodiments.

Although the cavities 43 are provided side by side in a row in the width direction in the housing 40 in the above first embodiment, the cavities 43 may be arranged in a plurality of stages in the vertical direction.

Although the top part 91 is provided at the position near the front side of the protrusion 90 in the above first embodiment, the top part 91 may be provided at another position (center in the front-rear direction, position near a rear side, or the like).

Although the upper surface (top surface) of the top part is disposed along the front-rear direction in the above first and second embodiments, the top part may have a tapered shape or may be shaped to be inclined to the front-rear direction.

### LIST OF REFERENCE NUMERALS

10 . . . connector device
20 . . . connector
30 . . . mating connector
31 . . . mating housing
32 . . . mating terminal fitting
33 . . . receptacle
34 . . . back wall
35 . . . receiving portion
36 . . . first projection
37 . . . second projection
40 . . . housing
40A . . . rear wall
40B . . . recess
41 . . . housing body
42 . . . outer tube portion
42A . . . first groove
42B . . . second groove
43 . . . cavity
44 . . . locking lance
45 . . . lock arm
46 . . . arm
47 . . . side wall
48 . . . lock portion
49 . . . operating portion
50 . . . retainer
51 . . . body portion
52 . . . first supporting portion
53 . . . front stop portion
54 . . . second supporting portion
55 . . . tab insertion hole
60 . . . sealing member
61 . . . sealing body
62 . . . protruding portion
70 . . . terminal fitting
71 . . . box portion
72 . . . crimping portion
73 . . . wire
74 . . . rubber plug
90 . . . protrusion
91 . . . top part
92 . . . front end
93 . . . curved surface
94 . . . rear end
95 . . . inclined surface
96 . . . rear end surface
210 . . . connector device
220 . . . connector
230 . . . mating connector
233 . . . receptacle
240 . . . housing
241 . . . housing body
250 . . . retainer
260 . . . sealing member
270 . . . terminal fitting
290 . . . protrusion
291 . . . top part
292 . . . front end
293 . . . curved surface
296 . . . rear end surface
390 . . . protrusion
391 . . . top part
393 . . . curved surface
395 . . . inclined surface
396 . . . rear end surface
490 . . . protrusion

1. A connector, comprising a connector and a mating connector connectable to the connector from front,
the mating connector including a tubular receptacle,
the connector including:
a housing having a housing body to be fit into the receptacle; and
a sealing member to be held in close contact with the receptacle by being mounted on an outer peripheral surface of the housing body,
a protrusion for filling a gap between the housing body and the receptacle being provided on the outer peripheral surface of the housing body, and
the protrusion being capable of facing and contacting the sealing member from a front side.

2. The connector device of claim 1, wherein the protrusion has:
a top part provided on a tip side in a projecting direction, and
a curved surface continuous from a front end of the protrusions to the top part.

3. The connector device of claim 1, wherein the protrusion has a curved surface convex forward from a front end of the protrusion to the top part when viewed from a projecting direction.

4. The connector device of claim 1, wherein the protrusion has an inclined surface approaching the housing body from the top part toward a rear side.

5. The connector device of claim 1, wherein a rear end surface of the protrusion is disposed along a projecting direction of the protrusion from the housing body.

6. The connector device of claim 1, wherein a rear end surface of the protrusion is a curved surface convex rearward when viewed from a projecting direction of the protrusion.
